(19) United States
(12) Patent Application Publication
(10) Pub. No.: US 2013/0286051 A1
(43) Pub. Date: Oct. 31, 2013

(54) MOBILE COMMUNICATION TERMINAL CONFIGURED TO DISPLAY DECODABLE INDICIA

(71) Applicants: Sean Philip Kearney, Marlton, NJ (US); Thomas Amundsen, Turnersville, NJ (US); Bejamin Hejl, Cherry Hill, NJ (US); Mark Schmidt, Waxhaw, NC (US); Taylor Smith, Charlotte, NC (US); Timothy Williams, Northport, NY (US)

(72) Inventors: Sean Philip Kearney, Marlton, NJ (US); Thomas Amundsen, Turnersville, NJ (US); Bejamin Hejl, Cherry Hill, NJ (US); Mark Schmidt, Waxhaw, NC (US); Taylor Smith, Charlotte, NC (US); Timothy Williams, Northport, NY (US)

(73) Assignee: Honeywell International Inc. doing business as (d.b.a.) Honeywell Scanning and Mobility, Fort Mill, SC (US)

(21) Appl. No.: 13/457,599

(22) Filed: Apr. 27, 2012

(51) Int. Cl. G09G 5/10; G09G 3/34

(52) U.S. Cl. 345/690; 345/84

(57) ABSTRACT

A mobile communication terminal can comprise a hand-held housing, a microprocessor disposed within the housing, a display incorporated into the housing and equipped with a backlight, a display adapter configured to control the display, a video memory configured to store data representing images displayed by the display, and a wireless communication interface at least partially disposed within the housing. The mobile communication terminal can be configured, responsive to detecting a byte sequence representing an image of decodable indicia being transferred to the video memory, to increase an intensity of the backlight to a pre-defined level, increase a timeout associated with the backlight to a pre-defined value, disable a power save mode for the display, and/or change a display color scheme to a pre-defined color scheme.

### FIELD OF THE INVENTION

The present invention relates generally to mobile communication terminals, and in particular to mobile communication terminals equipped with a backlit display.

### BACKGROUND OF THE INVENTION

Most liquid crystal display (LCD) screens are equipped with an internal light source, e.g., a backlight. Backlights illuminate the LCD from the side or back of the display panel. Backlights are typically used in small displays to increase readability in low light conditions.

Mobile devices with backlit displays are widely used for displaying decodable indicia, for example, airline boarding passes, coupons, loyalty program cards, etc. However, successful decoding of the displayed decodable indicia significantly depends upon the backlight intensity which can vary from device to device due to various device-specific parameters, including user-configurable settings.

### SUMMARY OF THE INVENTION

In one embodiment, there is provided a mobile communication terminal comprising a hand-held housing, a microprocessor disposed within the housing, a display incorporated into the housing and equipped with a backlight, a display adapter configured to control the display, a video memory configured to store data representing images displayed by the display, and a wireless communication interface at least partially disposed within the housing. The mobile communication terminal can be configured, responsive to detecting a byte sequence representing an image of decodable indicia being transferred to the video memory, to increase an intensity of the backlight to a pre-defined level, increase a timeout associated with the backlight to a pre-defined value, disable a power save mode for the display, and/or change a display color scheme to a pre-defined color scheme.

In a further aspect, the video memory can be configured to store a plurality of color values corresponding to a plurality of pixels displayed by the display.

In a further aspect, the mobile communication terminal can be configured to receive the byte sequence from an external computer. Alternatively, the mobile communication terminal can be configured to generate the byte sequence based on a message received from an external computer.

In some embodiments, the mobile communication terminal can be further configured to accept a user input to select the pre-defined backlight intensity level, the pre-defined timeout value, and/or the pre-defined color scheme.

In some embodiments, the mobile communication terminal can be further configured, upon expiration of a pre-defined timeout, to revert to the intensity of the backlight, the timeout associated with the backlight, the power save mode, and/or the color scheme to their respective original values.

In some embodiments, the mobile communication terminal can further comprise an encoded information reading (EIR) device provided by a bar code reading device, an RFID reading device, or a card reading device. The EIR device can be configured to perform at least one of: outputting raw message data containing an encoded message and outputting decoded message data corresponding to an encoded message.

In some embodiments, the mobile communication terminal can be provided by an EIR terminal, a smart phone, a mobile phone, or a personal digital assistant (PDA).

In another embodiment, there is provided a mobile communication terminal comprising a hand-held housing, a microprocessor disposed within the housing, a display incorporated into the housing and equipped with a backlight, a display adapter configured to control the display, and a wireless communication interface at least partially disposed within the housing. The mobile communication terminal can be adapted to execute a software module configured to display decodable indicia. The software module can be configured, responsive to receiving a byte sequence representing an image of decodable indicia, to display the image of decodable indicia on the display and perform at least one of: increasing an intensity of the backlight to a pre-defined level, increasing a timeout associated with the backlight to a pre-defined value, disabling a power save mode for the display, and changing display color scheme to a pre-defined color scheme.

In a further aspect, the mobile communication terminal can be configured to receive the byte sequence from an external computer. Alternatively, the mobile communication terminal can be configured to generate the byte sequence based on a message received from an external computer.

In some embodiments, the mobile communication terminal can be further configured to accept a user input to select the pre-defined backlight intensity level, the pre-defined timeout value, and the pre-defined color scheme.

In some embodiments, the mobile communication terminal can be further configured, upon expiration of a pre-defined timeout, to revert to the intensity of the backlight, the timeout associated with the backlight, the power save mode, and/or the color scheme to their respective original values.

In some embodiments, the mobile communication terminal can be provided by an EIR terminal, a smart phone, a mobile phone, or a personal digital assistant (PDA).

In a yet another embodiment, there is provided a method of displaying decodable indicia by a mobile communication terminal comprising a display equipped with a backlight, responsive to detecting a byte sequence representing an image of decodable indicia being transferred to the memory configured to store the data representing images displayed by the display. The method can comprise the step of increasing a readability of the decodable indicia by increasing an intensity of the backlight to a pre-defined level, increasing a timeout associated with the backlight to a pre-defined value, disabling a power save mode for the display, and/or changing display color scheme to a pre-defined color scheme. The method can further comprise the step of displaying the decodable indicia on the display.

In some embodiments, the mobile communication terminal can be provided by an EIR terminal, a smart phone, a mobile phone, or a personal digital assistant (PDA).

In some embodiments, the mobile communication terminal can comprise a hand-held housing, a microprocessor disposed within the housing, a display incorporated into the housing and equipped with a backlight, a display adapter configured to control the display, and a wireless communication interface at least partially disposed within the housing.

In some embodiments, the method can further comprise the step of receiving the byte sequence from an external computer, preceding the step of displaying the decodable indicia. Alternatively, the method can further comprise the step of generating the byte sequence based on a message received from an external computer, preceding the step of displaying the decodable indicia.

In some embodiments, the method can further comprise the step of accepting a user input to select the pre-defined backlight intensity level, the pre-defined timeout value, and/or the pre-defined color scheme, preceding the step of displaying the decodable indicia.

In some embodiments, the method can further comprise the step of reverting to the intensity of the backlight, the timeout associated with the backlight, the power save mode, and/or the color scheme to their respective original values, following the step of displaying the decodable indicia.

In a yet another embodiment, there is provided a method of displaying decodable indicia by a software module executable by a mobile communication terminal comprising a display equipped with a backlight. The method can comprise the step of receiving a byte sequence representing an image of the decodable indicia. The method can further comprise the step of increasing a readability of the decodable indicia by increasing an intensity of the backlight to a pre-defined level, increasing a timeout associated with the backlight to a pre-defined value, disabling a power save mode for the display, and/or changing display color scheme to a pre-defined color scheme. The method can further comprise the step of displaying the decodable indicia on the display.

In some embodiments, the mobile communication terminal can be provided by an EIR terminal, a smart phone, a mobile phone, or a personal digital assistant (PDA).

In some embodiments, the mobile communication terminal can comprise a hand-held housing, a microprocessor disposed within the housing, a display incorporated into the housing and equipped with a backlight, a display adapter configured to control the display, and a wireless communication interface at least partially disposed within the housing.

In some embodiments, the method can further comprise the step of accepting a user input to select the pre-defined backlight intensity level, the pre-defined timeout value, and/or the pre-defined color scheme, preceding the step of displaying the decodable indicia.

In some embodiments, the method can further comprise the step of reverting to the intensity of the backlight, the timeout associated with the backlight, the power save mode, and/or the color scheme to their respective original values, following the step of displaying the decodable indicia.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIGS. 1a-1b schematically illustrate one embodiment of a mobile communication terminal;

FIG. 2 depicts a component-level layout of a mobile communication terminal; and

FIGS. 3-4 illustrate various embodiments of a method of displaying decodable indicia by a mobile communication terminal.

The drawings are not necessarily to scale, emphasis instead generally being placed upon illustrating the principles of the invention. In the drawings, like numerals are used to indicate like parts throughout the various views.

### DETAILED DESCRIPTION OF THE INVENTION

There is provided a mobile communication terminal comprising a display equipped with a backlight. The mobile communication terminal can be provided, e.g., by a mobile phone. Alternatively, the mobile communication terminal can be provided by a smart phone. In a yet another embodiment, the mobile communication terminal can be provided by a personal digital assistant (PDA). In a further embodiment, the mobile communication terminal can be provided by an encoded information reading (EIR) terminal adapted, e.g., to read and decode bar codes.

The mobile communication terminal described herein can be used for displaying decodable indicia, for example, airline boarding passes, coupons, loyalty program cards, etc. The readability of displayed decodable indicia can be adversely affected by a number of factors. For example, a power save scheme selected by the device user can impose a level of the backlight intensity which could be insufficient for optical indicia reading devices. In another example, the power save scheme can impose a backlit timeout (i.e., the time period elapsed before switching the backlight off due to the user interface inactivity) which could be less than the time required to reliably read the decodable indicia.

To increase the readability of displayed decodable indicia, the mobile communication terminal can be configured to increase the backlight intensity to a pre-defined level, increase the backlight timeout to a pre-defined value, disable the display power save mode, and/or change display color scheme to a pre-defined color scheme.

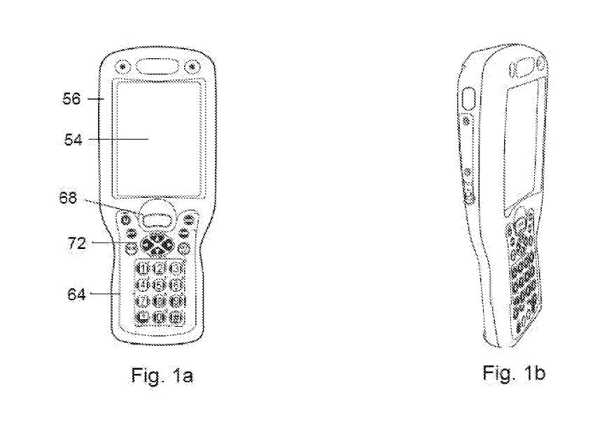

One embodiment of a mobile communication terminal is shown in FIGS. 1a (front panel view) and 1b (side panel view). The mobile communication terminal 100 can comprise a housing 52 within which other components of mobile communication terminal 100 can be disposed. A display 54 equipped with backlight can be disposed on the front panel 56. Also disposed on the front panel 56 can be a keyboard 64 including functional keys 68, navigation keys 72, and/or numeric keys. A skilled artisan would appreciate the fact that other types and form factors of mobile communication terminal housings are within the scope of this disclosure.

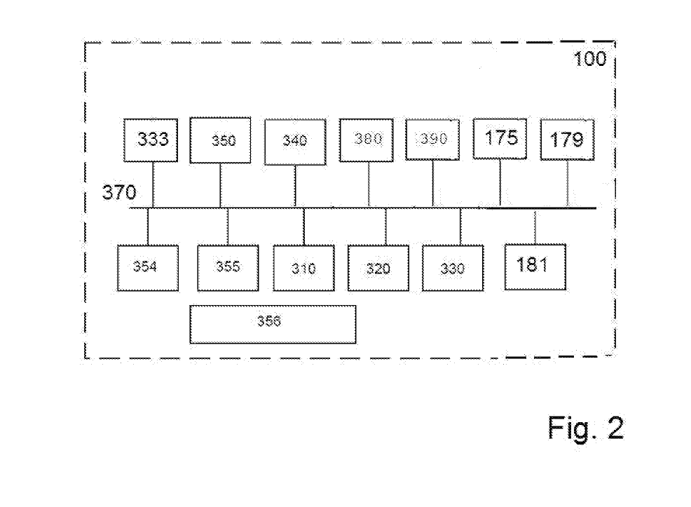

Component-level diagram of one embodiment of the mobile communication terminal is now being described with references to FIG. 2. The mobile communication terminal 100 can comprise at least one microprocessor 310 and a memory 320, both coupled to the system bus 370. The microprocessor 310 can be provided by a general purpose microprocessor or by a specialized microprocessor (e.g., an ASIC). In one embodiment, mobile communication terminal 100 can comprise a single microprocessor which can be referred to as a central processing unit (CPU). In another embodiment, mobile communication terminal 100 can comprise two or more microprocessors, for example, a CPU providing some or most of the mobile communication terminal functionality and a specialized microprocessor performing some specific functionality. A skilled artisan would appreciate the fact that other schemes of processing tasks distribution among two or more microprocessors are within the scope of this disclosure.

Mobile communication terminal 100 can further comprise a communication interface 340 communicatively coupled to the system bus 370. In one embodiment, the communication interface can be provided by a wireless communication interface. The wireless communication interface can be configured to support, for example, but not limited to, the following protocols: at least one protocol of the IEEE 802.11/802.15/802.16 protocol family, at least one protocol of the HSPA/GSM/GPRS/EDGE protocol family, TDMA protocol, UMTS protocol, LTE protocol, and/or at least one protocol of the CDMA/1xEV-DO protocol family.

Mobile communication terminal 100 can further comprise a battery 356. In one embodiment, the battery 356 can be provided by a replaceable rechargeable battery pack. The mobile communication terminal 100 can further comprise a GPS receiver 380. The mobile communication terminal 100 can further comprise at least one connector 390 configured to receive a subscriber identity module (SIM) card.

Mobile communication terminal 100 can further comprise an imaging device 330, provided, for example, by a two-dimensional imager.

Mobile communication terminal 100 can further comprise a user interface including a display adapter 175 and a keyboard 179. In a further aspect, at least part of memory 320 can be designated as video memory and can be configured to store a plurality of color values corresponding to a plurality of pixels displayed by said display.

In one embodiment, the mobile communication terminal 100 can further comprise an audio output device, e.g., a speaker 181.

In some embodiments, the mobile communication terminal 100 can further comprise an EIR device 333. The EIR device can be provided, for example, by a bar code reading device, an RFID reading device, and/or a card reading device. The EIR device can be configured to output raw message data containing an encoded message and/or output decoded message data corresponding to an encoded message. As used herein, “message” is intended to denote a byte sequence or a character string comprising alphanumeric and/or non-alphanumeric characters. An encoded message can be used to convey information, such as identification of the source and the model of an item, for example, in an EPC code.

In a further aspect, mobile communication terminal 100 can be in communication with an external computer, e.g., via wireless communication interface 340. A “computer” herein shall refer to a programmable device for data processing and control, including a central processing unit (CPU), a memory, and at least one communication interface. For example, in one embodiment, a computer can be provided by a server running a single instance of a multi-tasking operating system. In another embodiment, a computer can be provided by a virtual server, i.e., an isolated instance of a guest operating system running within a host operating system. A “network” herein shall refer to a set of hardware and software components implementing a plurality of communication channels between two or more computers. A network can be provided, e.g., by a local area network (LAN), or a wide area network (WAN). While different networks can be designated herein, it is recognized that a single network as seen from the application layer interface to the network layer of the OSI model can comprise a plurality of lower layer networks, i.e., what can be regarded as a single Internet Protocol (IP) network, can include a plurality of different physical networks. In one embodiment, the communications between the mobile communication terminal 100 and the external computer 171 can comprise a series of requests and responses transmitted over one or more TCP connections. A skilled artisan would appreciate the fact that using other transport and application level protocols is within the scope and the spirit of the invention.

In a further aspect, at least one of the messages received by the mobile communication terminal 100 can include a byte sequence representing an image of decodable indicia (e.g., a bar code) which the mobile communication terminal can display on the display 54. In another embodiment, at least one of the messages received by the mobile communication terminal 100 can include a message which the mobile communication terminal 100 can encode into decodable indicia (e.g., a bar code) and the display on the display 54.

As noted herein supra, the mobile communication terminal 100 can be adapted to increase the readability of the decodable indicia displayed on the display 54 by increasing the backlight intensity to a pre-defined level, increasing the backlight timeout to a pre-defined value, disabling the display power save mode, and/or changing display color scheme to a pre-defined color scheme.

In a further aspect, the mobile communication terminal 100 can be configured to detect an attempt of a software module being executed by the terminal to display an image of the decodable indicia. In one embodiment, the display driver executed by the mobile communication terminal can be configured to detect a transfer to its video memory of a byte sequence representing an image of decodable indicia.

A “driver” herein shall refer to a software module allowing other software modules interact with a hardware device (for example, a keyboard, a display, a printer, etc.). A driver can communicate with the device via the system bus and/or via one or more I/O ports. A driver can also provide handing of one or more hardware interrupts generated by the device. A display driver can read/write to and from one or more blocks of memory associated with the display, which can be referred to as video memory.

Responsive to detecting the transfer, the display driver can increase the backlight intensity to a pre-defined level, increase the backlight timeout to a pre-defined value, disable the display power save mode, and/or change display color scheme to a pre-defined color scheme. In one embodiment, one or more of the above functions can be performed before the transfer to the video memory of a byte sequence representing an image of decodable indicia is complete. In another embodiment, one or more of the above functions can be performed in parallel with the transfer to the video memory of a byte sequence representing an image of decodable indicia. In a yet another embodiment, one or more of the above functions can be performed after the transfer to the video memory of a byte sequence representing an image of decodable indicia is complete.

In a further aspect, one or more configurable parameters can be associated with one or more of the above described functions, for example, the backlight intensity, the backlight timeout, and/or the color scheme to be used. In one embodiment, one or more parameters can be configurable by a user of the mobile communication terminal.

In one embodiment, the mobile communication terminal can be configured to revert the affected settings (for example, the backlight intensity, the backlight timeout, and/or the color scheme) to their original values upon expiration of a pre-defined timeout.

In a further aspect, the above described functionality can be implemented by one or more software modules (e.g., a display driver). In another embodiment, the above described functionality can be implemented by one or more hardware components. In a yet another embodiment, the above described functionality can be implemented by one or more software modules and one or more hardware components.

Invoking the above described readability increasing functionality responsive to detecting a video memory transfer can be particularly useful if the mobile communication terminal allows executing third-party software modules, which can be oblivious with respect to the above described readability increasing functionality.

In another embodiment, the mobile communication terminal can comprise a software module configured to display decodable indicia. The software module can be configured, responsive to receiving a byte sequence representing an image of decodable indicia, to display the image of decodable indicia on display 54. The software module can be further configured to increase the backlight intensity to a pre-defined level, increase the backlight timeout to a pre-defined value, disable the display power save mode, and/or change display color scheme to a pre-defined color scheme. In one embodiment, one or more of the above functions can be performed before displaying the decodable indicia. In another embodiment, one or more of the above functions can be performed in parallel with displaying the decodable indicia. In a yet another embodiment, one or more of the above functions can be performed after displaying the decodable indicia.

In a further aspect, one or more configurable parameters can be associated with one or more of the above described functions, for example, the backlight intensity, the backlight timeout, and/or the color scheme to be used. In one embodiment, one or more parameters can be configurable by a user of the mobile communication terminal.

In one embodiment, the mobile communication terminal can be configured to revert the affected settings (for example, the backlight intensity, the backlight timeout, and/or the color scheme) to their original values upon expiration of a pre-defined timeout.

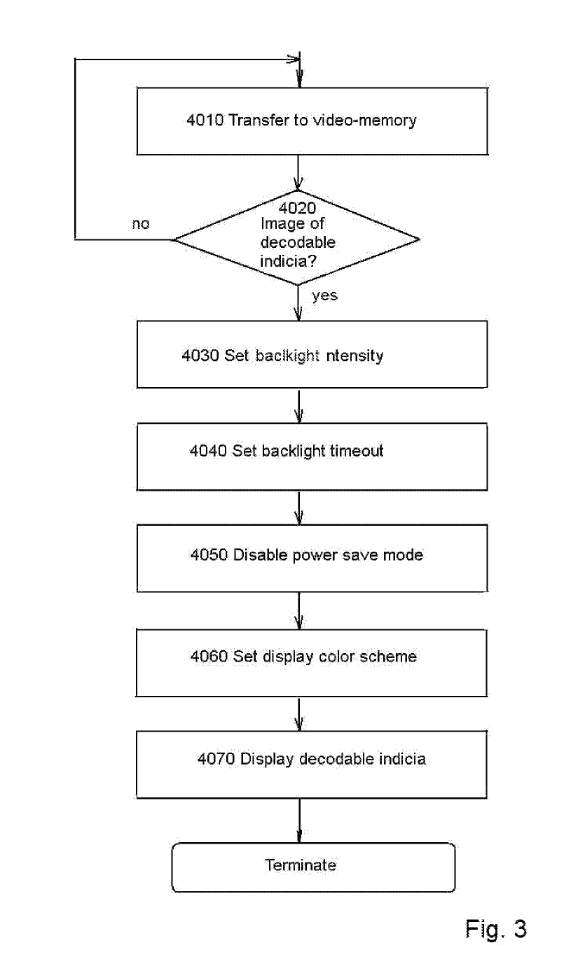

One embodiment of a method of displaying decodable indicia by a decodable indicia displaying process executed by a mobile communication terminal is now being described with references to FIG. 3. A “process” herein shall refer to an instance of a computer program that is being executed; in some operating systems, several processes can be instantiated simultaneously. In some operating systems, several processes can be executed concurrently. In some operating systems, several processes can be instantiated simultaneously from the same computer program.

Processing commences by the decodable indicia displaying process detecting another process (e.g., instantiated by a third-party application program) transferring to the video memory of a byte sequence representing an image of decodable indicia at the loop defined by blocks 4010-4020. In one embodiment, the detection of video memory transfer can be implemented by an interrupt servicing routine (ISR) handling the video memory access interrupts. In one embodiment, the detection of video memory transfer can be implemented by an interrupt servicing routine (ISR) handling direct memory access (DMA) interrupts. A skilled artisan would appreciate the fact that other methods of detecting a transfer to the video memory of a byte sequence representing an image of decodable indicia are within the scope of this disclosure.

At step 4030, the decodable indicia displaying process can increase the backlight intensity to a pre-defined level.

At step 4040, the decodable indicia displaying process can increase the backlight timeout to a pre-defined value.

At step 4050, the decodable indicia displaying process can disable the display power save mode.

At step 4060, the decodable indicia displaying process can change display color scheme to a pre-defined color scheme.

In various embodiments of the method, the operations described in blocks 4030-4060 can be performed in any order. In some embodiments, some of the operations described in blocks 4030-4060 can be omitted.

At step 4070, the decodable indicia displaying process can display the decodable indicia, e.g., by completing the transfer to the video memory of a byte sequence representing an image of the decodable indicia. In another embodiment, the video memory transfer can be completed before performing the operations described in blocks 4030-4060. In a yet another embodiment, the video memory transfer can be completed in parallel with the operations described in blocks 4030-4060.

Upon completing operations described in block 4070, the decodable indicia displaying process can terminate.

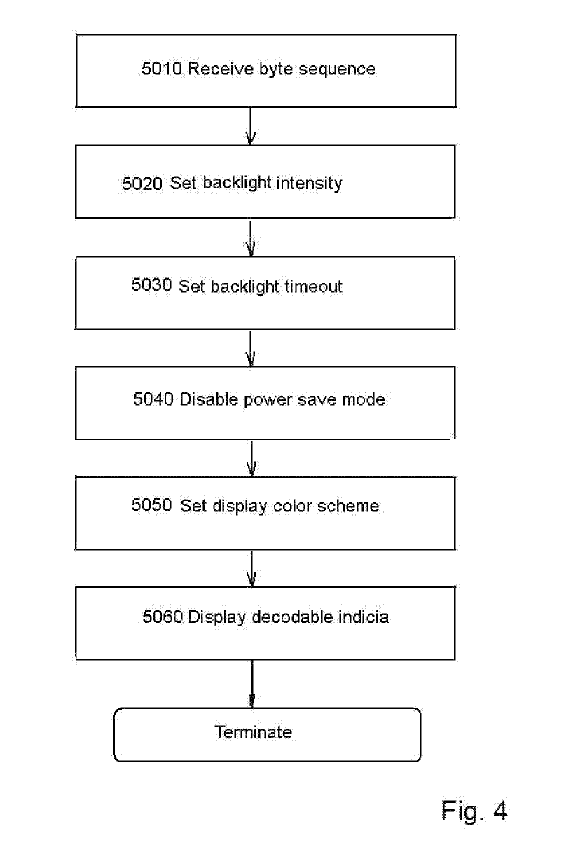

Another embodiment of a method of displaying decodable indicia by a decodable indicia displaying process executed by a mobile communication terminal is now being described with references to FIG. 4.

Processing commences by the decodable indicia displaying process receiving a byte sequence representing an image of decodable indicia at blocks 5010. In one embodiment, the decodable indicia displaying process can receive a pointer to a memory buffer containing the byte sequence representing the image of the decodable indicia. In one embodiment, the decodable indicia displaying process can allocate a memory buffer for the invoking process copying the byte sequence representing the image of the decodable indicia. A skilled artisan would appreciate the fact that other methods of the decodable indicia displaying process receiving a byte sequence representing an image of decodable indicia are within the scope of this disclosure.

At step 5020, the decodable indicia displaying process can increase the backlight intensity to a pre-defined level.

At step 5030, the decodable indicia displaying process can increase the backlight timeout to a pre-defined value.

At step 5040, the decodable indicia displaying process can disable the display power save mode.

At step 5050, the decodable indicia displaying process can change display color scheme to a pre-defined color scheme.

In various embodiments of the method, the operations described in blocks 5030-5050 can be performed in any order. In some embodiments, some of the operations described in blocks 5020-5050 can be omitted.

At step 5060, the decodable indicia displaying process can display the decodable indicia, e.g., by completing the transfer to the video memory of a byte sequence representing an image of the decodable indicia. In another embodiment, the video memory transfer can be completed before performing the operations described in blocks 5020-5050. In a yet another embodiment, the video memory transfer can be completed in parallel with the operations described in blocks 5020-5050.

Upon completing operations described in block 5060, the decodable indicia displaying process can terminate.

While the present invention has been particularly shown and described with reference to certain exemplary embodiments, it will be understood by one skilled in the art that various changes in detail may be affected therein without departing from the spirit and scope of the invention as defined by claims that can be supported by the written description and drawings. Further, where exemplary embodiments are described with reference to a certain number of elements it will be understood that the exemplary embodiments can be practiced utilizing less than the certain number of elements.

A small sample of systems, methods, and apparata that are described herein is as follows:

A1. A mobile communication terminal comprising:

a hand-held housing;

a microprocessor disposed within said housing;

a display equipped with a backlight, said display incorporated into said housing;

a display adapter communicatively coupled to said microprocessor, said display adapter configured to control said display;

a video memory communicatively coupled to said display adapter, said video memory configured to store data representing images displayed by said display; and

a wireless communication interface communicatively coupled to said microprocessor, said wireless communication interface at least partially disposed within said housing;

wherein said mobile communication terminal is configured, responsive to detecting a byte sequence representing an image of decodable indicia being transferred to said video memory, to perform at least one of: increasing an intensity of said backlight to a pre-defined level, increasing a timeout associated with said backlight to a pre-defined value, disabling a power save mode for said display, and changing a display color scheme to a pre-defined color scheme.

A2. The mobile communication terminal of (A1), wherein said video memory is configured to store a plurality of color values corresponding to a plurality of pixels displayed by said display.

A3. The mobile communication terminal of (A1), wherein said mobile communication terminal is configured to receive said byte sequence from an external computer.

A4. The mobile communication terminal of (A1), wherein said mobile communication terminal is configured to generate said byte sequence based on a message received from an external computer.

A5. The mobile communication terminal of (A1), further configured to accept a user input to select at least one of: said pre-defined level, said pre-defined value, and said pre-defined color scheme.

A6. The mobile communication terminal of (A1), further configured, upon expiration of a pre-defined timeout, to revert to original values at least one of: said intensity of said backlight, said timeout associated with said backlight, said power save mode, and said color scheme.

A7. The mobile communication terminal of (A1), further comprising an encoded information reading (EIR) device selected from the group consisting of: a bar code reading device, an RFID reading device, and a card reading device;

wherein said EIR device is configured to perform at least one of: outputting raw message data containing an encoded message and outputting decoded message data corresponding to an encoded message.

A8. The mobile communication terminal of (A1), wherein said mobile communication terminal is provided by one of: an EIR terminal, a smart phone, a mobile phone, and a PDA.

B1. A mobile communication terminal comprising:

a hand-held housing;

a microprocessor disposed within said housing;

a display equipped with a backlight, said display incorporated into said housing;

a display adapter communicatively coupled to said microprocessor, said display adapter configured to control said display;

a wireless communication interface communicatively coupled to said microprocessor, said wireless communication interface at least partially disposed within said housing; and

a software module configured to display decodable indicia;

wherein said software module is configured, responsive to receiving a byte sequence representing an image of decodable indicia, to display said image of decodable indicia on said display and perform at least one of: increasing an intensity of said backlight to a pre-defined level, increasing a timeout associated with said backlight to a pre-defined value, disabling a power save mode for said display, and changing display color scheme to a pre-defined color scheme.

B2. The mobile communication terminal of (B1), wherein said mobile communication terminal is configured to receive said byte sequence from an external computer.

B3. The mobile communication terminal of (B1), wherein said mobile communication terminal is configured to generate said byte sequence based on a message received from an external computer.

B3. The mobile communication terminal of (B1), further configured to accept a user input to select at least one of: said pre-defined level, said pre-defined value, and said pre-defined color scheme.

B5. The mobile communication terminal of (B1), further configured, upon expiration of a pre-defined timeout, to revert to original values at least one of: said intensity of said backlight, said timeout associated with said backlight, said power save mode, and said color scheme.

B6. The mobile communication terminal of (B1), wherein said mobile communication terminal is provided by one of: an EIR terminal, a smart phone, a mobile phone, and a PDA.

C1. A method of displaying decodable indicia by a mobile communication terminal comprising a display equipped with a backlight, responsive to detecting a byte sequence representing an image of decodable indicia being transferred to a memory configured to store data representing images displayed by said display, said method comprising the steps of:

increasing a readability of said decodable indicia by performing at least one of:

(i) increasing an intensity of said backlight to a pre-defined level;

(ii) increasing a timeout associated with said backlight to a pre-defined value;

(iii) disabling a power save mode for said display;

(iv) changing display color scheme to a pre-defined color scheme; and

displaying said decodable indicia on said display.

C2. The method of (C1), wherein said mobile communication terminal is provided by one of: an EIR terminal, a smart phone, a mobile phone, and a PDA.

C3. The method of (C1), wherein said mobile communication terminal comprises:

a hand-held housing;

a microprocessor disposed within said housing;

a display equipped with a backlight, said display incorporated into said housing;

a display adapter communicatively coupled to said microprocessor, said display adapter configured to control said display; and

a wireless communication interface communicatively coupled to said microprocessor, said wireless communication interface at least partially disposed within said housing.

C4. The method of (C1), further comprising the step of said mobile communication terminal receiving said byte sequence from an external computer, preceding said step of displaying said decodable indicia.

C5. The method of (C1), further comprising the step of said mobile communication terminal generating said byte sequence based on a message received from an external computer, preceding said step of displaying said decodable indicia.

C6. The method of (C1), further comprising the step of said mobile communication terminal accepting a user input to select at least one of: said pre-defined level, said pre-defined value, and said pre-defined color scheme, preceding said step of displaying said decodable indicia.

C7. The method of (C1), further comprising the step of said mobile communication terminal reverting to original values at least one of: said intensity of said backlight, said timeout associated with said backlight, said power save mode, and said color scheme, following said step of displaying said decodable indicia.

D1. A method of displaying decodable indicia by a software module executable by a mobile communication terminal comprising a display equipped with a backlight, said method comprising the steps of:

receiving a byte sequence representing an image of said decodable indicia;

increasing a readability of said decodable indicia by performing at least one of:

(i) increasing an intensity of said backlight to a pre-defined level;

(ii) increasing a timeout associated with said backlight to a pre-defined value;

(iii) disabling a power save mode for said display;

(iv) changing display color scheme to a pre-defined color scheme; and

displaying said decodable indicia on said display.

D2. The method of (D1), wherein said mobile communication terminal comprises:

a microprocessor communicatively coupled to a system bus;

a memory communicatively coupled to said system bus;

an EIR device communicatively coupled to said system bus, the EIR device selected from the group consisting of: a bar code reading device, an RFID reading device, and a card reading device; and

a wireless communication interface.

D3. The method of (D1), wherein said mobile communication terminal is provided by one of: an EIR terminal, a smart phone, a mobile phone, and a PDA.

D4. The method of (D1), further comprising the step of said mobile communication terminal accepting a user input to select at least one of: said pre-defined level, said pre-defined value, and said pre-defined color scheme, preceding said step of displaying said decodable indicia.

D5. The method of (D1), further comprising the step of said mobile communication terminal reverting to original values at least one of: said intensity of said backlight, said timeout associated with said backlight, said power save mode, and said color scheme, following said step of displaying said decodable indicia.

1. A mobile communication terminal comprising:
a hand-held housing;
a microprocessor disposed within said housing;
a display equipped with a backlight, said display incorporated into said housing;
a display adapter communicatively coupled to said microprocessor, said display adapter configured to control said display;
a video memory communicatively coupled to said display adapter, said video memory configured to store data representing images displayed by said display; and
a wireless communication interface communicatively coupled to said microprocessor, said wireless communication interface at least partially disposed within said housing;
wherein said mobile communication terminal is configured, responsive to detecting a byte sequence representing an image of decodable indicia being transferred to said video memory, to perform at least one of: increasing an intensity of said backlight to a pre-defined level, increasing a timeout associated with said backlight to a pre-defined value, disabling a power save mode for said display, and changing a display color scheme to a pre-defined color scheme.

2. The mobile communication terminal of claim 1, wherein said video memory is configured to store a plurality of color values corresponding to a plurality of pixels displayed by said display.

3. The mobile communication terminal of claim 1, wherein said mobile communication terminal is configured to receive said byte sequence from an external computer.

4. The mobile communication terminal of claim 1, wherein said mobile communication terminal is configured to generate said byte sequence based on a message received from an external computer.

5. The mobile communication terminal of claim 1, further configured to accept a user input to select at least one of: said pre-defined level, said pre-defined value, and said pre-defined color scheme.

5. The mobile communication terminal of claim 1, further configured, upon expiration of a pre-defined timeout, to revert to original values at least one of: said intensity of said backlight, said timeout associated with said backlight, said power save mode, and said color scheme.

7. The mobile communication terminal of claim 1, further comprising an encoded information reading (EIR) device selected from the group consisting of: a bar code reading device, an RFID reading device, and a card reading device;
wherein said EIR device is configured to perform at least one of: outputting raw message data containing an encoded message and outputting decoded message data corresponding to an encoded message.

8. The mobile communication terminal of claim 1, wherein said mobile communication terminal is provided by one of: an EIR terminal, a smart phone, a mobile phone, and a PDA.

9. A mobile communication terminal comprising:
a hand-held housing;
a microprocessor disposed within said housing;
a display equipped with a backlight, said display incorporated into said housing;
a display adapter communicatively coupled to said microprocessor, said display adapter configured to control said display;
a wireless communication interface communicatively coupled to said microprocessor, said wireless communication interface at least partially disposed within said housing; and
a software module configured to display decodable indicia;
wherein said software module is configured, responsive to receiving a byte sequence representing an image of decodable indicia, to display said image of decodable indicia on said display and perform at least one of: increasing an intensity of said backlight to a pre-defined level, increasing a timeout associated with said backlight to a pre-defined value, disabling a power save mode for said display, and changing display color scheme to a pre-defined color scheme.

10. The mobile communication terminal of claim 9, wherein said mobile communication terminal is configured to receive said byte sequence from an external computer.

11. The mobile communication terminal of claim 9, wherein said mobile communication terminal is configured to generate said byte sequence based on a message received from an external computer.

12. The mobile communication terminal of claim 9, further configured to accept a user input to select at least one of: said pre-defined level, said pre-defined value, and said pre-defined color scheme.

13. The mobile communication terminal of claim 9, further configured, upon expiration of a pre-defined timeout, to revert to original values at least one of: said intensity of said backlight, said timeout associated with said backlight, said power save mode, and said color scheme.

14. The mobile communication terminal of claim 9, wherein said mobile communication terminal is provided by one of: an EIR terminal, a smart phone, a mobile phone, and a PDA.

15. A method of displaying decodable indicia by a mobile communication terminal comprising a display equipped with a backlight, responsive to detecting a byte sequence representing an image of decodable indicia being transferred to a memory configured to store data representing images displayed by said display, said method comprising the steps of:
increasing a readability of said decodable indicia by performing at least one of:
(v) increasing an intensity of said backlight to a pre-defined level;
(vi) increasing a timeout associated with said backlight to a pre-defined value;
(vii) disabling a power save mode for said display;
(viii) changing display color scheme to a pre-defined color scheme; and
displaying said decodable indicia on said display.

16. The method of claim 15, wherein said mobile communication terminal is provided by one of: an EIR terminal, a smart phone, a mobile phone, and a PDA.

17. The method of claim 15, wherein said mobile communication terminal comprises:
a hand-held housing;
a microprocessor disposed within said housing;
a display equipped with a backlight, said display incorporated into said housing;
a display adapter communicatively coupled to said microprocessor, said display adapter configured to control said display; and
a wireless communication interface communicatively coupled to said microprocessor, said wireless communication interface at least partially disposed within said housing.

18. The method of claim 15, further comprising the step of said mobile communication terminal receiving said byte sequence from an external computer, preceding said step of displaying said decodable indicia.

19. The method of claim 15, further comprising the step of said mobile communication terminal generating said byte sequence based on a message received from an external computer, preceding said step of displaying said decodable indicia.

20. The method of claim 15, further comprising the step of said mobile communication terminal accepting a user input to select at least one of: said pre-defined level, said pre-defined value, and said pre-defined color scheme, preceding said step of displaying said decodable indicia.

21. The method of claim 15, further comprising the step of said mobile communication terminal reverting to original values at least one of: said intensity of said backlight, said timeout associated with said backlight, said power save mode, and said color scheme, following said step of displaying said decodable indicia.

22. A method of displaying decodable indicia by a software module executable by a mobile communication terminal comprising a display equipped with a backlight, said method comprising the steps of:
receiving a byte sequence representing an image of said decodable indicia;
increasing a readability of said decodable indicia by performing at least one of:
(v) increasing an intensity of said backlight to a pre-defined level;
(vi) increasing a timeout associated with said backlight to a pre-defined value;
(vii) disabling a power save mode for said display;
(viii) changing display color scheme to a pre-defined color scheme; and
displaying said decodable indicia on said display.

23. The method of claim 22, wherein said mobile communication terminal comprises:
a microprocessor communicatively coupled to a system bus;
a memory communicatively coupled to said system bus;
an EIR device communicatively coupled to said system bus, the EIR device selected from the group consisting of: a bar code reading device, an RFID reading device, and a card reading device; and
a wireless communication interface.

24. The method of claim 22, wherein said mobile communication terminal is provided by one of: an EIR terminal, a smart phone, a mobile phone, and a PDA.

25. The method of claim 22, further comprising the step of said mobile communication terminal accepting a user input to select at least one of: said pre-defined level, said pre-defined value, and said pre-defined color scheme, preceding said step of displaying said decodable indicia.

26. The method of claim 22, further comprising the step of said mobile communication terminal reverting to original values at least one of: said intensity of said backlight, said timeout associated with said backlight, said power save mode, and said color scheme, following said step of displaying said decodable indicia.
